(19) United States
(12) Patent Application Publication
(10) Pub. No.: US 2026/0269501 A1
(43) Pub. Date: Sep. 10, 2026

(54) CABLE ASSEMBLY STRUCTURE AND CONNECTOR

(71) Applicant: I-PEX Inc., Kyoto-shi, Kyoto (JP)

(72) Inventor: Takashi MASUNAGA, Ogori-shi (JP)

(21) Appl. No.: 18/875,570

(22) PCT Filed: May 23, 2023
(86) PCT No.: PCT/JP2023/019207

§ 371 Date: Dec. 16, 2024

(30) Foreign Application Priority Data
Jun. 17, 2022 (JP) 2022-098123

(51) Int. Cl. H01R 12/79; H01R 13/6581

(52) U.S. Cl. CPC H01R 12/79; H01R 13/6581

(57) ABSTRACT

In a cable assembly structure (10), a first cable assembly (1) and second cable assembly (2) are stacked into layers in the direction orthogonal to the extending and alignment directions of coaxial cables (3), such that the coaxial cables (3) extend in the same direction and a receptacle connector (30) is visible through the distal ends, and are installed in a plug connector (20) mated with the receptacle connector (30) in the stacking direction. In the first-layer first cable assembly (1), first ground bars (4A, 4B) hold the coaxial cables (3) at a first position (P1) of a gap between the coaxial cables (3) and a shell (24). In the second cable assembly (2), second ground bars (5A, 5B, 6A, 6B) hold the coaxial cables (3) at a second position (P 2) of another gap, and at a third position (P3) closer to the distal ends than the second position (P2).

### TECHNICAL FIELD

The present disclosure relates to a cable assembly structure and a connector.

### BACKGROUND ART

Patent Literature 1 discloses a connector including a multipole coaxial-cable connector assembly fabricated by stacking two coaxial cable assemblies on each other, each of which is an assembly of coaxial cables aligned in line.

### Citation List

### Patent Literature

Patent Literature 1: Japanese Patent No. 4068092.

### SUMMARY OF INVENTION

### Technical Problem

The connector disclosed in Patent Literature 1 has an outer circumference surrounded by a shell serving as a mechanism for shielding electromagnetic waves. The connector, however, has gaps between a second conductive shell 45 and coaxial cables 2, for example, as illustrated in FIG. 1 of Patent Literature 1. These gaps are suspected to allow for leakage or penetration of electromagnetic waves

An objective of the present disclosure, which has been accomplished in view of the above situations, is to provide a cable assembly structure and a connector that can reduce leakage or penetration of electromagnetic waves.

### Solution to Problem

In order to achieve the above objective, a cable assembly structure according to a first aspect of the present disclosure includes conductive contacts and a conductive cover member disposed around the conductive contacts, and constitutes a part of a connector to be mated with a mating connector. The cable assembly structure includes cable assemblies, each including cables aligned in line while distal ends of the cables where core wires in contact with the conductive contacts are exposed are adjusted to the same position, and a pair of conductive ground members electrically connected to the cover member and configured to hold the cables in portions where outer conductors of the cables are exposed. The cable assemblies are stacked in multiple layers in a direction orthogonal to both of an extending direction and an alignment direction of the cables, such that the cables of the cable assemblies extend in the same extending direction, and the mating connector is visible through the distal ends of the cables. The cable assemblies are installed in the connector to be mated with the mating connector in the direction of stacking the cable assemblies. In a first cable assembly stacked as a first layer closer to the mating connector among the stacked cable assemblies, a first ground member included in the pair of conductive ground members holds the cables at a first position corresponding to a gap between the cables and the cover member. In a second cable assembly other than the first cable assembly among the stacked cable assemblies, a second ground member included in the pair of conductive ground members holds the cables at a second position corresponding to a gap between the cables and the cover member, and at a third position closer to the distal ends than the second position.

The second cable assembly may include a first member to hold the cables at the second position, and a second member to hold the cables at the third position, which serve as the second ground member.

The first ground member may be electrically connected to the first member by soldering.

The first ground member may be electrically connected to the first member via the cover member.

The second ground member may include a member ranging from the second position to the third position.

The first ground member may be electrically connected to the second ground member by soldering.

The first ground member may be electrically connected to the second ground member via the cover member.

A connector according to a second aspect of the present disclosure includes the cable assembly structure according to the first aspect.

### Advantageous Effects of Invention

The present disclosure can reduce leakage or penetration of electromagnetic waves.

### BRIEF DESCRIPTION OF DRAWINGS

FIG. 1 is a perspective view illustrating the appearance of a first cable assembly and a second cable assembly according to Embodiment 1 of the present disclosure;

FIG. 2 is a perspective view illustrating the appearance of a connector pair before mating;

FIG. 3 is a perspective view illustrating the appearance of a plug connector;

FIG. 4A is a perspective view illustrating the appearance of the connector pair after mating;

FIG. 4B is a plan view of the connector pair illustrated in FIG. 4A;

FIG. 5A is a sectional view taken along the line VA-VA of FIG. 4B;

FIG. 5B is a sectional view taken along the line VB-VB of FIG. 4B;

FIG. 6A illustrates a result of electromagnetic interference (EMI) in the case of no ground bar between a shell and coaxial cables;

FIG. 6B illustrates a result of EMI in the case of a ground bar between a shell and coaxial cables;

FIG. 7A is a sectional view of a connector pair according to Embodiment 2 of the present disclosure, which corresponds to the sectional view taken along the line VA-VA of FIG. 4B;

FIG. 7B is a sectional view, which corresponds to the sectional view taken along the line VB-VB of FIG. 4B; and

FIG. 8 illustrates another example of a cable assembly structure.

### DESCRIPTION OF EMBODIMENTS

Embodiments of the present disclosure are described in detail below with reference to the accompanying drawings. In each of the drawings, the components identical or corresponding to each other are provided with the same reference symbol.

### Embodiment 1

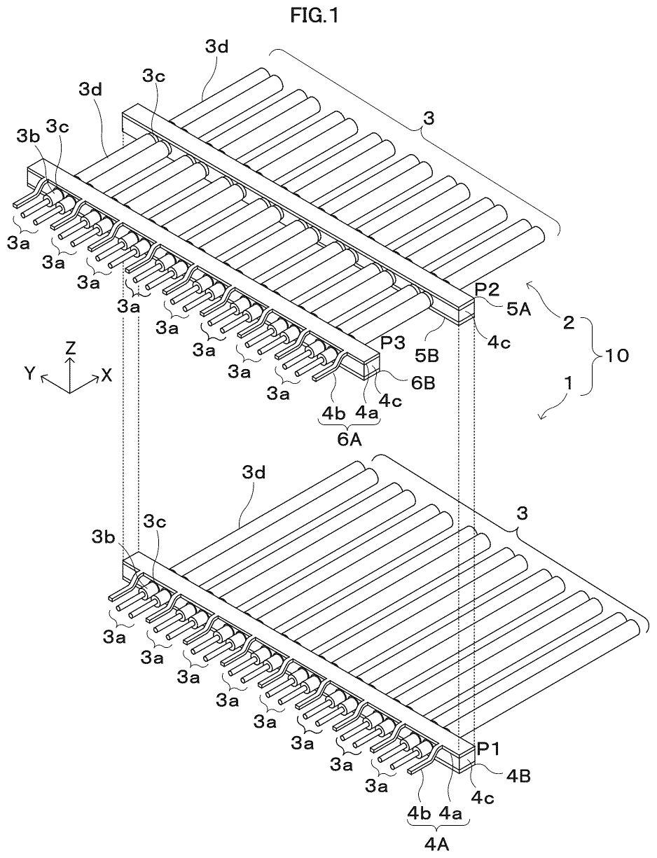

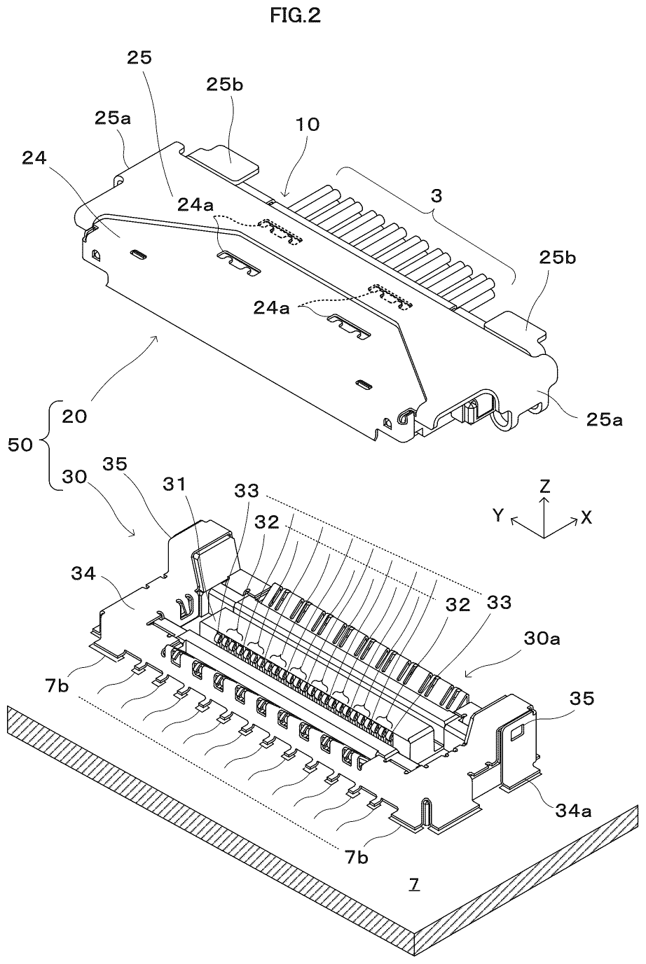

The following describes Embodiment 1 of the present disclosure. The description of Embodiment 1 first focuses on a cable assembly structure 10 including a first cable assembly 1 and a second cable assembly 2, with reference to FIG. 1. The description then focuses on a plug connector 20 including the cable assembly structure 10 and a receptacle connector 30, with reference to FIG. 2. The description then focuses on a connector pair 50 including the plug connector 20 and the receptacle connector 30, with reference to FIG. 2. The cable assembly structure 10 provides a structure for reducing leakage or penetration of electromagnetic waves between the interior and exterior of the connector pair 50.

### First Cable Assembly

As illustrated in FIG. 1, the first cable assembly 1 includes multiple coaxial cables 3, and a pair of first ground bars 4A and 4B serving as a first ground member. FIG. 1 illustrates only a part of the first cable assembly 1 adjacent to one ends of the coaxial cables 3 without illustrating the other parts.

### Coaxial Cables

The coaxial cables 3 are of the identical type and have the same diameter, for example. The coaxial cables 3 are aligned in line while extending in the same direction. FIG. 1 defines the extending direction in which the coaxial cables 3 extend to be X-axis direction, and defines the alignment direction in which the coaxial cables 3 are aligned to be Y-axis direction. FIG. 1 also defines the direction orthogonal to both of the extending direction and the alignment direction to be Z-axis direction. The following description refers to this XYZ orthogonal coordinate system.

As illustrated in FIG. 1, each of the coaxial cables 3 includes a core wire 3a extending in the extending direction, a dielectric 3b disposed over the outer periphery of the core wire 3a extending in the extending direction, an outer conductor 3c disposed over the outer periphery of the dielectric 3b extending in the extending direction, and an outermost sheath 3d disposed over the outer periphery of the outer conductor 3c extending in the extending direction. The outer conductor 3c is grounded, as described below. The dielectric 3b insulates the core wire 3a from the outer conductor 3c. The core wire 3a and the outer conductor 3c thus have a potential difference, which determines a voltage level of signals transmitted through the coaxial cable 3.

The radial circumference around the core wire 3a serving as the center is covered with the outer conductor 3c on the outer periphery of the dielectric 3b. The outer conductor 3c can thus reduce the levels of penetration and leakage of electromagnetic waves between the core wire 3a and the external space.

The coaxial cables 3 are grouped into pairs. A pair of coaxial cables 3 transmits a differential signal. The first cable assembly 1 includes multiple pairs of coaxial cables 3, specifically, eight pairs of coaxial cables 3. The pairs of coaxial cables 3 adjacent to each other have an interval therebetween, of which a width is approximately equal to the width of a single cable. Each pair of coaxial cables 3 transmits a differential signal having a voltage level determined by the potential difference between the core wires 3a of the coaxial cables 3.

In each of the coaxial cables 3, the outer peripheries extending in the extending direction are exposed in the order of the core wire 3a, the dielectric 3b, the outer conductor 3c, and the outermost sheath 3d, from one end in the extending direction (end adjacent to the negative side of the X axis relative to the center of the coaxial cable 3). The coaxial cables 3 have the same length of the exposed outer peripheries of the core wires 3a, which is sufficiently long for the soldering with signal contacts 22 of the plug connector 20 described below. The coaxial cables 3 have the same length of the exposed outer peripheries of the outer conductor 3c in the extending direction, which is equal to or longer than the X-axis width of the first ground bars 4A and 4B described below. The coaxial cables 3 are aligned in the alignment direction such that the core wires 3a, the dielectrics 3b, and the outer conductors 3c are individually adjusted to the same positions in the extending direction.

### First Ground Bars

As illustrated in FIG. 1, the first ground bars 4A and 4B are each a rectangular flat-plate member made of a conductive material (for example, metal), and extend in the alignment direction of the coaxial cables 3. The first ground bars 4A and 4B do not necessarily need to have a rectangular shape. The first ground bars 4A and 4B are only required to extend in the alignment direction of the coaxial cables 3 and be in contact with the outer conductors 3c of all the coaxial cables 3.

The first ground bar 4A is disposed such that the longitudinal direction thereof accords with the alignment direction of the coaxial cables 3, while being in contact with the exposed outer peripheries of the outer conductors 3c from the +Z side (positive side of the Z axis relative to the X axis: upper side) in the thickness direction. The first ground bar 4B is disposed such that the longitudinal direction thereof accords with the alignment direction of the coaxial cables 3, while being in contact with the exposed outer peripheries of the outer conductors 3c from the-Z side (negative side of the Z axis relative to the X axis: lower side) in the thickness direction. The first ground bars 4A and 4B have a length in the alignment direction equal to or longer than the length across all the coaxial cables 3 in the alignment direction.

The pair of first ground bars 4A and 4B are thus in contact with the outer conductors 3c and hold the coaxial cables 3 therebetween in the Z-axis direction. The first ground bars 4A and 4B hold the outer conductors 3c therebetween at a position in the extending direction, which is defined as first position P1.

The first ground bar 4A includes a flat plate segment 4a in contact with the outer conductors 3c, and conductive ground joint segments 4b that partition the exposed core wires 3a of the adjacent pair of coaxial cables 3. The ground joint segments 4b extend in parallel to the extending direction of the exposed core wires 3a. The ground joint segments 4b each extend from the edge of the flat plate segment 4a closer to one end of the coaxial cable 3 (negative end in the X-axis direction relative to the center of the coaxial cable 3 in the extending direction) to an interval between the exposed core wires 3a of the adjacent pair of coaxial cables 3, are bent into the direction in which the first ground bars 4A and 4B are opposed to each other, and bent again into the direction parallel to the extending direction of the core wires 3a of the coaxial cables 3.

The first ground bar 4B is a flat plate member in contact with the outer conductors 3c. The first ground bar 4B and the flat plate segment 4a of the first ground bar 4A define gaps therebetween, which are filled with solder. These gaps filled with solder constitute the soldered segments 4c.

### Second Cable Assembly

As illustrated in FIG. 1, the second cable assembly 2 includes multiple coaxial cables 3, a pair of conductive second ground bars 5A and 5B serving as a second ground member, and a pair of second ground bars 6A and 6B also serving as a second ground member. The coaxial cables 3 are of the identical type and have the same diameter. Although the description of Embodiment 1 assumes that the coaxial cables 3 of the second cable assembly 2 are of the identical type and have the same diameter as the coaxial cables 3 of the first cable assembly 1, this configuration is a mere example.

The coaxial cables 3 of the second cable assembly 2 are aligned in the same direction as the coaxial cables 3 of the first cable assembly 1, and extend in the same extending direction as the coaxial cables 3 of the first cable assembly 1. The coaxial cables 3 of the second cable assembly 2 are aligned in the same alignment direction as the coaxial cables 3 of the first cable assembly 1, such that the distal ends including the exposed core wires 3a are adjusted to the same position.

While the outer conductors 3c in the first cable assembly 1 are exposed at a single position, the outer conductors 3c in the second cable assembly 2 are exposed at two positions. Among the two positions, one position closer to the proximal ends (ends adjacent to the positive side of the X axis relative to the centers of the coaxial cables 3 in the extending direction) in the extending direction of the coaxial cables 3 is defined as second position P2, and the other position closer to the distal ends (ends adjacent to the negative side of the X axis relative to the centers of the coaxial cables 3 in the extending direction) is defined as third position P3.

The second ground bars 5A and 5B hold the coaxial cables 3 therebetween at the second position P2. The second ground bars 6A and 6B hold the coaxial cables 3 therebetween at the third position P3. While the second ground bar 6A has ground joint segments 4b like the first ground bar 4A, the second ground bar 5A has no ground joint segment 4b.

The first cable assembly 1 and the second cable assembly 2 are stacked into multiple layers in the direction (Z-axis direction) orthogonal to the extending direction and the alignment direction, such that the coaxial cables 3 of the cable assemblies extend in the same extending direction, and the mating connector, that is, the receptacle connector 30 to be mated is visible through the distal ends of the cable assemblies. The Z-axis direction in which the cable assemblies are stacked is also called the stacking direction.

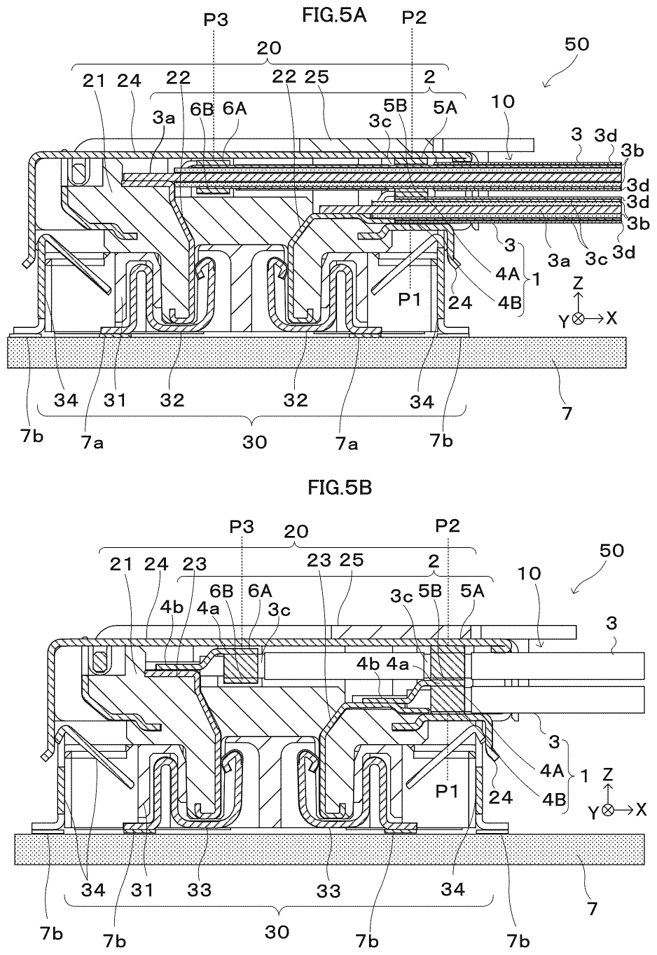

The distal ends through which the receptacle connector 30 is visible indicates a structure in which the distal ends of the cable assembly located above in the stacking direction protrude further in the extending direction than the distal ends of the cable assembly located below (for example, a structure in which the distal ends of the cable assembly located above in the stacking direction have a smaller X coordinate). The distal ends of the coaxial cables 3 of the first cable assembly 1 and the second cable assembly 2 do not need to be exposed at the lower surface of the plug connector 20 to be opposed to the receptacle connector 30. The distal ends of the second cable assembly 2 in the second layer are only required to protrude in the extending direction further than the distal ends of the first cable assembly 1 in the first layer, such that the exposed outer peripheries of the core wires 3a of the coaxial cables 3 of the first cable assembly 1 do not overlap with those of the second cable assembly 2 in the stacking direction (refer to FIGS. 5A and 5B).

In this embodiment, the first cable assembly 1 and the second cable assembly 2 are stacked on each other such that the first position P1 accords with the second position P2 in the extending direction. This arrangement causes the second ground bar 5B to be opposed to the first ground bar 4A (refer to FIG. 1).

In this embodiment, the first ground bar 4A is electrically connected to the second ground bar 5B by soldering. The first ground bar 4A is also electrically connected to the second ground bar 5B via a shell 24, serving as a cover member of the plug connector 20 (refer to FIGS. 5A and 5B).

The stacked cable assemblies constitute the cable assembly structure 10. The first cable assembly 1 and the second cable assembly 2 are installed in the plug connector 20, as illustrated in FIG. 2. The first cable assembly 1 and the second cable assembly 2 stacked in multiple layers can reduce the lengths of the plug connector 20 and the receptacle connector 30 in the alignment direction, leading to a reduction in the area occupied by the connector pair 50.

The first cable assembly 1 and the second cable assembly 2 include the same number of coaxial cables 3 in this embodiment, but may include different numbers of coaxial cables 3. The coaxial cables 3 of the cable assemblies are located at the same position in the Y-axis direction in this embodiment, but may be displaced from each other by a half pitch, for example.

### Connector Pair

As illustrated in FIG. 2, the connector pair 50 includes the plug connector 20 and the receptacle connector 30. The cable assembly structure 10 is installed in the plug connector 20 serving as a connector, and the receptacle connector 30 is mounted on a substrate 7.

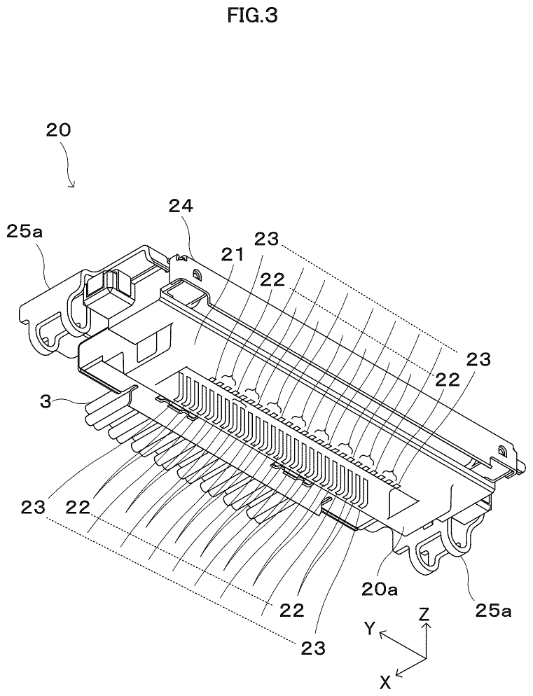

As illustrated in FIG. 2, the receptacle connector 30 has a slot 30a open toward the positive side of the Z-axis direction. The slot 30a is a recess having a rectangular frame shape. In contrast, as illustrated in FIG. 3, the plug connector 20 has an insertable protrusion 20a protruding toward the negative side of the Z-axis direction. The insertable protrusion 20a is a protrusion having a rectangular frame shape. The insertable protrusion 20a is inserted into the slot 30a, and thus causes the plug connector 20 to be mated with the receptacle connector 30.

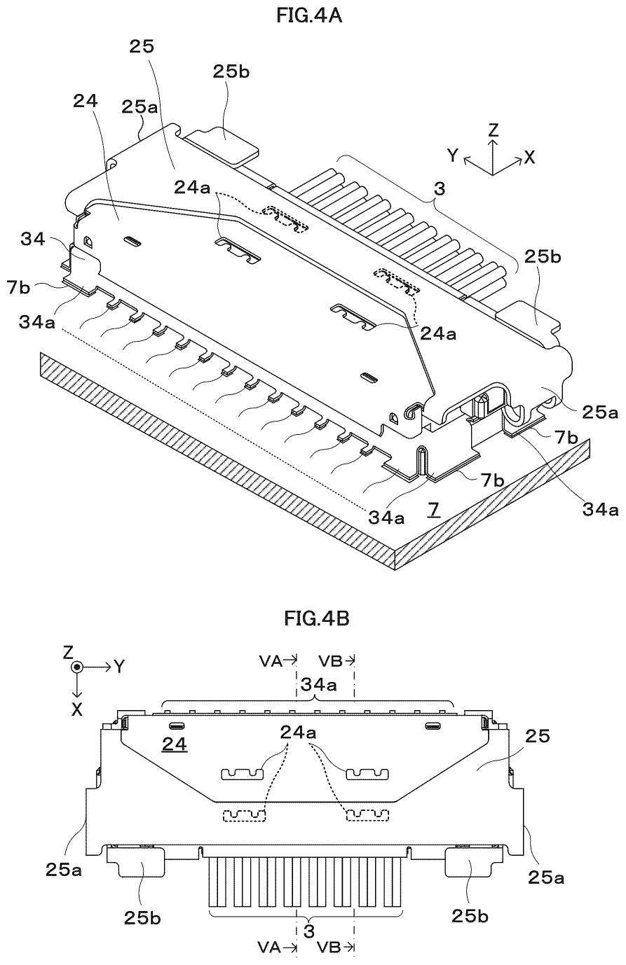

As illustrated in FIGS. 4A and 4B, the mating of the plug connector 20 with the receptacle connector 30 in the Z-axis direction achieves electrical connection between the coaxial cables 3 of the cable assembly structure 10 installed in the plug connector 20 and electrical circuits of the substrate 7. The plug connector 20 is mated with the receptacle connector 30 in the stacking direction of the first cable assembly 1 and the second cable assembly 2, that is, the Z-axis direction.

Plug connector

The following describes the plug connector 20. As illustrated in FIGS. 5A and 5B, the plug connector 20 includes the above-described cable assembly structure 10, a housing 21 made of an insulating material, the signal contacts 22 serving as conductive contacts, conductive ground contacts 23 also serving as conductive contacts, the conductive shell 24 serving as a cover member, and an engaging unit 25 that maintains the mating with the receptacle connector 30.

The housing 21 is a casing of the plug connector 20 made of an insulating resin, for example. The housing 21 is provided with the signal contacts 22 and the ground contacts 23 by press fitting or insert molding. The signal contacts 22 and the ground contacts 23 are arranged in the alignment direction of the coaxial cables 3. The signal contacts 22 and the ground contacts 23 are arranged in two arrays, including a first array for connection to the core wires 3a of the coaxial cables 3 of the first cable assembly 1, and a second array for connection to the core wires 3a of the coaxial cables 3 of the second cable assembly 2.

In the first array, the signal contacts 22 are arranged in contact with the core wires 3a of the coaxial cables 3 of the first cable assembly 1 (refer to FIG. 5A). The ground contacts 23 are arranged in contact with the ground joint segments 4b of the first cable assembly 1 (refer to FIG. 5B). The ground contacts 23 are disposed on both sides of each pair of signal contacts 22 in the alignment direction.

In the second array, the signal contacts 22 are arranged in contact with the core wires 3a of the coaxial cables 3 of the second cable assembly 2 (refer to FIG. 5A). The ground contacts 23 are arranged in contact with the ground joint segments 4b of the second cable assembly 2 (refer to FIG. 5B). The ground contacts 23 are disposed on both sides of each pair of signal contacts 22 in the alignment direction.

As illustrated in FIG. 3, the shell 24 is disposed around the signal contacts 22 and the ground contacts 23 while being insulated from the signal contacts 22 and the ground contacts 23. The shell 24 has contact tab areas 24a (refer to FIGS. 4A and 4B). The contact tab areas 24a have tabs to come into contact with the second ground bars 5A and 6A of the second cable assembly 2. As illustrated in FIG. 5B, the shell 24 is also in contact with the first ground bar 4B of the first cable assembly 1. The shell 24 is in contact with a shell 34 of the receptacle connector 30 and thus grounded to the substrate 7, as described below. The shell 24 configures an electromagnetic wave shield surrounding the signal contacts 22 and the ground contacts 23, and thus reduces leakage or penetration of electromagnetic waves to or from the external space.

The engaging unit 25 is mounted such that the engaging unit 25 is rotatable relative to the shell 24. The engaging unit 25 includes locking sections 25a for engagement with the receptacle connector 30, and unlocking sections 25b (refer to FIG. 2). The locking sections 25a and the unlocking sections 25b are located at both ends in the alignment direction. When the plug connector 20 is mated with the receptacle connector 30, the locking sections 25a engage with the sections of an engaged unit 35 of the receptacle connector 30. The unlocking sections 25b can release the engagement between the locking sections 25a and the sections of the engaged unit 35 in response to a manual operation. The released engagement allows the plug connector 20 to be separated from the receptacle connector 30.

### Receptacle Connector

The following describes the receptacle connector 30. As illustrated in FIG. 2, the receptacle connector 30 includes an insulating housing 31, conductive signal contacts 32, conductive ground contacts 33, the conductive shell 34, and the engaged unit 35.

The housing 31 is a casing of the receptacle connector 30 made of an insulating resin, for example. The housing 31 is provided with the signal contacts 32 and the ground contacts 33 by press fitting or insert molding. The signal contacts 32 and the ground contacts 33 are arranged in the alignment direction of the coaxial cables 3.

The signal contacts 32 and the ground contacts 33 are arranged in two arrays, including a first array for connection to the signal contacts 22 connected to the core wires 3a of the coaxial cables 3 of the first cable assembly 1 and the ground contacts 23, and a second array for connection to the signal contacts 22 connected to the core wires 3a of the coaxial cables 3 of the second cable assembly 2 and the ground contacts 23.

In the first array, the signal contacts 32 are arranged to be in contact with the signal contacts 22, and soldered to signal electrodes 7a of the substrate 7. The ground contacts 33 are arranged to be in contact with the ground contacts 23, and soldered to ground electrodes 7b of the substrate 7. The ground contacts 23 are disposed on both sides of each pair of signal contacts 22 in the alignment direction.

In the second array, the signal contacts 32 are arranged to be in contact with the signal contacts 22, and soldered to the signal electrodes 7a of the substrate 7. The ground contacts 33 are arranged to be in contact with the ground contacts 23, and soldered to the ground electrodes 7b of the substrate 7. The ground contacts 23 are disposed on both sides of each pair of signal contacts 22 in the alignment direction.

As illustrated in FIG. 2, the shell 34 is disposed around the signal contacts 32 and the ground contacts 33. The shell 34 is located at a position to be in contact with the shell 24 of the plug connector 20. The shell 34 includes substrate joints 34a to be grounded to the substrate 7. The shell 34 can reduce leakage or penetration of electromagnetic waves between the signal contacts 32 or the ground contacts 33 and the external space.

The engaged unit 35 has sections disposed on both ends in the alignment direction. The respective sections of the engaged unit 35 engage with the locking sections 25a of the engaging unit 25 of the plug connector 20.

### Transmission Paths

The plug connector 20 and the receptacle connector 30 define transmission paths between the coaxial cables 3 and the substrate 7. As illustrated in FIG. 5A, the core wires 3a of the coaxial cables 3 of the first cable assembly 1, the signal contacts 22, the signal contacts 32, and the signal electrodes 7a of the substrate 7 are connected in sequence, and thus define transmission paths for signals of the first array. Furthermore, the core wires 3a of the coaxial cables 3 of the second cable assembly 2, the signal contacts 22, the signal contacts 32, and the signal electrodes 7a of the substrate 7 are connected in sequence, and thus define transmission paths for signals of the second array. Since each pair of coaxial cables 3 transmits a differential signal in the first cable assembly 1 and the second cable assembly 2 as described above, the connector pair 50 has pairs of transmission paths for signal transmission, and each pair of transmission paths transmits a differential signal.

As illustrated in FIG. 5B, the outer conductors 3c of the coaxial cables 3 of the first cable assembly 1, the flat plate segment 4a and the ground joint segments 4b of the first ground bar 4A, the ground contacts 23, the ground contacts 33, and the ground electrodes 7b of the substrate 7 are connected in sequence, and thus define transmission paths for grounding of the first array. Furthermore, the outer conductors 3c of the coaxial cables 3 of the second cable assembly 2, the flat plate segment 4a and the ground joint segments 4b of the first ground bar 6A, the ground contacts 23, the ground contacts 33, and the ground electrodes 7b of the substrate 7 are connected in sequence, and thus define transmission paths for grounding of the second array. These transmission paths for grounding are disposed on both sides of each pair of the transmission paths for signal transmission in the Y-axis direction (alignment direction).

As illustrated in FIG. 5B, the first ground bars 4A and 4B, the second ground bars 5A and 5B, and the second ground bars 6A and 6B are in contact with the shell 24. The shell 24 of the plug connector 20 is in contact with the shell 34 of the receptacle connector 30. The substrate joints 34a of the shell 34 of the receptacle connector 30 are arranged so as to surround the signal contacts 32 and the ground contacts 33 on the XY plane (main surface) of the substrate 7, and are connected to the ground electrodes 7b of the substrate 7 by soldering. These shells 24 and 34 therefore configure an electromagnetic wave shield that surrounds the transmission paths for signal transmission from all the directions.

As illustrated in FIGS. 5A and 5B, the first ground bars 4A and 4B are disposed at the first position P1 corresponding to a gap between the shell 24 and the coaxial cables 3. The second ground bars 5A and 5B are disposed at the second position P2 corresponding to a gap between the shell 24 and the coaxial cables 3. In addition, the first ground bar 4A is connected to the second ground bar 5B by soldering. The first ground bars 4A and 4B and the second ground bars 5A and 5B thus function as members for shielding electromagnetic waves passing through the gaps between the shell 24 and the coaxial cables 3.

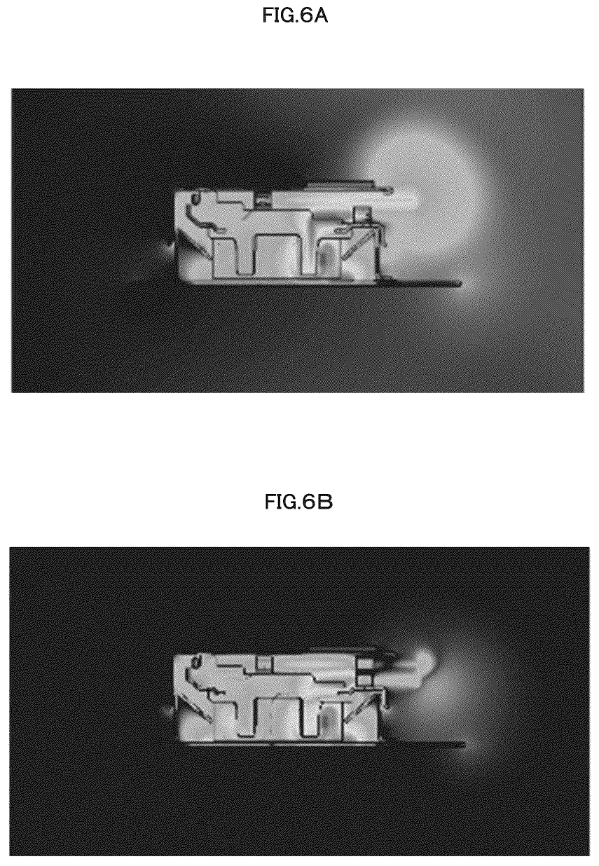

FIG. 6A illustrates a result of EMI in the case where the first ground bars 4A and 4B and the second ground bars 5A and 5B are not disposed between the shell 24 and the coaxial cables 3, specifically, the first cable assembly 1 includes the first ground bars 4A and 4B without the second ground bars 5A and 5B in the second cable assembly 2 as in an existing cable assembly. FIG. 6B illustrates a result of EMI of the connector pair 50 according to this embodiment in which the first ground bars 4A and 4B and the second ground bars 5A and 5B are disposed between the shell 24 and the coaxial cables 3. FIGS. 6A and 6B illustrate a higher intensity of electromagnetic waves with a brighter color.

The comparison between FIGS. 6A and 6B reveals that the second ground bars 5A and 5B can reduce leakage of electromagnetic waves through the gaps between the shell 24 and the coaxial cables 3. As is obvious from these results of EMI, the second ground bars 5A and 5B can also reduce penetration of electromagnetic waves into the interior of the connector pair 50 through the gaps between the shell 24 and the coaxial cables 3.

As described in detail above, the first ground bars 4A and 4B and the second ground bars 5A and 5B close the gaps between the shell 24 and the coaxial cables 3 in the plug connector 20 in this embodiment, and can thus reduce leakage or penetration of electromagnetic waves.

### Embodiment 2

The following describes Embodiment 2 of the present disclosure. The cable assembly structure 10 according to Embodiment 2 has the configuration identical to the cable assembly structure 10 according to Embodiment 1 described above, except for the second cable assembly 2.

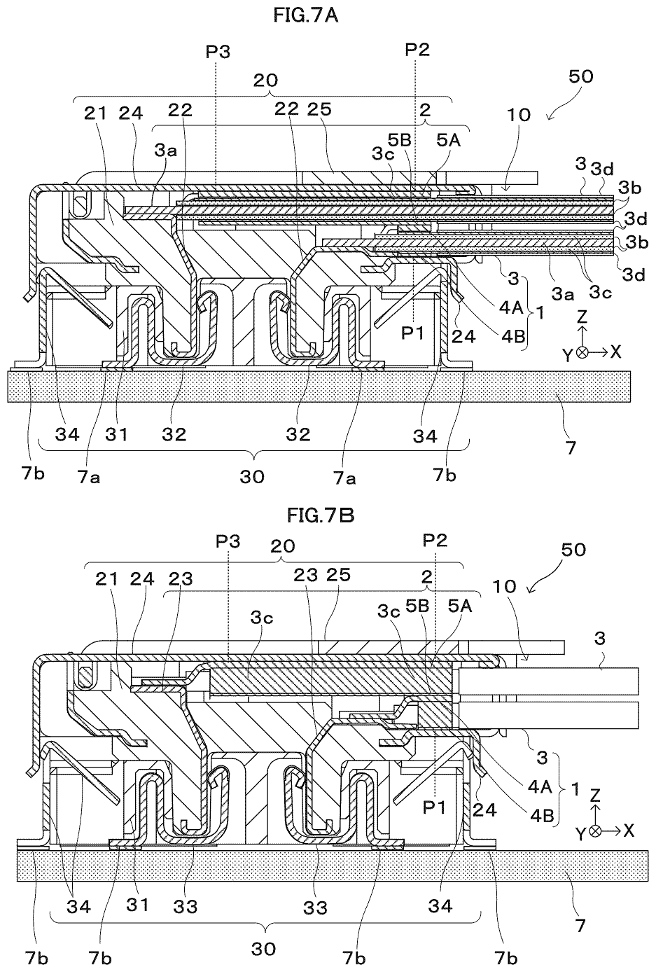

In Embodiment 1 described above, the second cable assembly 2 includes the second ground bars 5A and 5B and the second ground bars 6A and 6B. In contrast, a second cable assembly 2 in this embodiment, which is illustrated in FIGS. 7A and 7B, differs from that in Embodiment 1 in that the second cable assembly 2 includes second ground bars 5A and 5B ranging from the second position P2 to the third position P3 and excludes second ground bars 6A and 6B.

In this embodiment, the conductive first ground bars 4A and 4B and the conductive second ground bars 5A and 5B close the gaps between the shell 24 and the coaxial cables 3 in the plug connector 20, and can more effectively reduce leakage or penetration of electromagnetic waves. Furthermore, the second ground bars 5A and 5B cover the portions of the coaxial cables 3 including the exposed outer conductors 3c in the second cable assembly 2, and can match the impedance in the portions.

The first ground bar 4A may be electrically connected to the second ground bar 5B by soldering in this embodiment. The first ground bar 4A may also be electrically connected to the second ground bar 5B via the shell 24. This electrical connection can block the gaps between the first cable assembly 1 and the second cable assembly 2, and can even more effectively reduce leakage or penetration of electromagnetic waves.

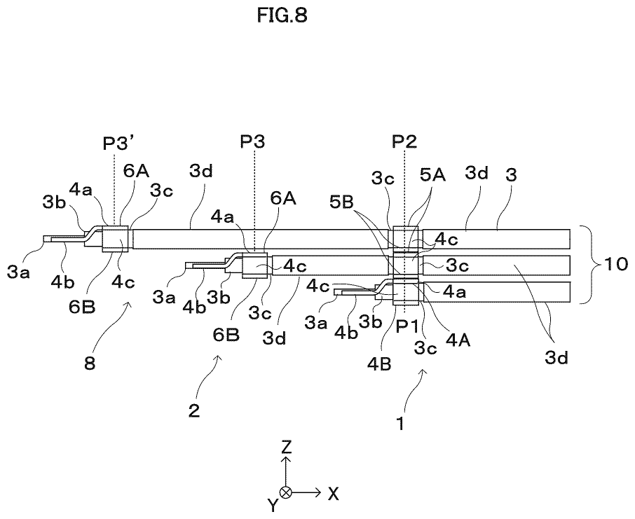

Alternatively, as illustrated in FIG. 8, the cable assembly structure 10 may include three cable assemblies stacked on each other. In this case, the cable assembly structure 10 includes a third-layer second cable assembly 8 stacked on a second-layer second cable assembly 2, which is stacked on a first-layer first cable assembly 1. The second cable assembly 8 also includes second ground bars 5A and 5B that hold the coaxial cables 3 therebetween at the second position P2 corresponding to a gap between the coaxial cables 3 and the shell 24, and second ground bars 6A and 6B that hold the coaxial cables 3 therebetween at a third position P3′ closer to the distal ends than the second position P2, like the second cable assembly 2.

The third position P3′ differs from the third position P3 in the X-axis direction so that the receptacle connector 30 is visible through the distal ends of the coaxial cables 3 of the second cable assembly 8. Alternatively, the cable assembly structure 10 may include four or more cable assemblies stacked on each other. In this case, the cable assemblies are arranged such that the receptacle connector 30 is visible through the distal ends of all the cable assemblies.

Although the first ground bar 4A of the first cable assembly 1 is in contact with the second ground bar 5B of the second cable assembly 2 in the above-described embodiments, this configuration is a mere example. Alternatively, the first ground bar 4A and the second ground bar 5B may receive a conductive member inserted therebetween, for example. In this case, the first ground bars 4A and 4B, the second ground bars 5A and 5B, and the inserted member constitute a mechanism for shielding electromagnetic waves.

Although the above description of the embodiments focuses on the configuration of one ends of the coaxial cables 3 alone, the other ends of the coaxial cables 3 may also have the same configuration. That is, the other ends of the coaxial cables 3 may constitute the first cable assembly 1 and the second cable assembly 2, and the plug connector 20 including the first cable assembly 1 and the second cable assembly 2 may be mated with the receptacle connector 30 to be connected to another substrate.

Although the cable assembly structure 10, the plug connector 20, and the connector pair 50 transmit differential signals in the above-described embodiments, these configurations are mere examples. The present disclosure may also be applied to a cable assembly structure for transmitting single-ended signals.

Although each cable assembly includes eight pairs of coaxial cables 3 in the above-described embodiments, this configuration is a mere example. The cable assembly may include any number of coaxial cables 3.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-98123, filed on Jun. 17, 2022, the entire disclosure of which is incorporated by reference herein.

### INDUSTRIAL APPLICABILITY

The present disclosure can be applied to the connection between substrates with coaxial cables, for example.

### REFERENCE SIGNS LIST

1 First cable assembly
2 Second cable assembly
3 Coaxial cable
3a Core wire
3b Dielectric
3c Outer conductor
3d Outermost sheath
4A, 4B First ground bar (first ground member)
4a Flat plate segment
4b Ground joint segment
4c Soldered segment
5A, 5B, 6A, 6B Second ground bar (second ground member)
7 Substrate
7a Signal electrode
7b Ground electrode
8 Second cable assembly
10 Cable assembly structure
20 Plug connector (connector)
20a Insertable protrusion
21 Housing
22 Signal contact (conductive contact)
23 Ground contact (conductive contact)
24 Shell (cover member)
24a Contact tab area
25 Engaging unit
25a Locking section
25b Unlocking section
30 Receptacle connector (mating connector)
30a Slot
31 Housing
32 Signal contact
33 Ground contact
34 Shell
34a Substrate joint
35 Engaged unit
50 Connector pair

1. A cable assembly structure including conductive contacts and a conductive cover member disposed around the conductive contacts, the cable assembly structure constituting a part of a connector to be mated with a mating connector, the cable assembly structure comprising:
cable assemblies, each including
cables aligned in line while distal ends of the cables where core wires in contact with the conductive contacts are exposed are adjusted to a same position, and
a pair of conductive ground members electrically connected to the cover member, and configured to hold the cables in portions where outer conductors of the cables are exposed, wherein
the cable assemblies are stacked in multiple layers in a direction orthogonal to both of an extending direction and an alignment direction of the cables, such that the cables of the cable assemblies extend in a same extending direction, and the mating connector is visible through the distal ends of the cables,
the cable assemblies are installed in the connector to be mated with the mating connector in the direction of stacking the cable assemblies,
in a first cable assembly stacked as a first layer closer to the mating connector among the stacked cable assemblies, a first ground member included in the pair of conductive ground members holds the cables at a first position corresponding to a gap between the cables and the cover member, and
in a second cable assembly other than the first cable assembly among the stacked cable assemblies, a second ground member included in the pair of conductive ground members holds the cables at a second position corresponding to a gap between the cables and the cover member, and at a third position closer to the distal ends than the second position.

2. The cable assembly structure according to claim 1, wherein the second cable assembly includes
a first member to hold the cables at the second position, and
a second member to hold the cables at the third position, the first member and the second member serving as the second ground member.

3. The cable assembly structure according to claim 2, wherein the first ground member is electrically connected to the first member by soldering.

4. The cable assembly structure according to claim 2, wherein the first ground member is electrically connected to the first member via the cover member.

5. The cable assembly structure according to claim 1, wherein the second ground member includes a member ranging from the second position to the third position.

6. The cable assembly structure according to claim 5, wherein the first ground member is electrically connected to the second ground member by soldering.

7. The cable assembly structure according to claim 5, wherein the first ground member is electrically connected to the second ground member via the cover member.

8. A connector comprising:
the cable assembly structure according claim 1.
